(19) United States
(12) Patent Application Publication
(10) Pub. No.: US 2019/0283262 A1
(43) Pub. Date: Sep. 19, 2019

(54) CUTTING TOOL WITH CUTTING EDGE AND METHOD FOR MANUFACTURING SAME

(71) Applicants: Hangzhou United Tools Co., Ltd., Hangzhou City, Zhejiang Province (CN); Hangzhou Great Star Industrial Co., Ltd., Hangzhou City, Zhejiang Province (CN)

(72) Inventor: Weiyi Wang, Hangzhou City, Zhejiang Province (CN)

(73) Assignees: Hangzhou United Tools Co., Ltd., Hangzhou City, Zhejiang Province, OT (CN); Hangzhou Great Star Industrial Co., Ltd., Hangzhou City, Zhejiang Province, OT (CN)

(21) Appl. No.: 15/764,896

(22) PCT Filed: Mar. 13, 2018
(86) PCT No.: PCT/CN2018/078784

§ 371 Date: Mar. 30, 2018

(51) Int. Cl. B26B 9/00; C21D 1/09

(52) U.S. Cl. CPC B26B 9/00; C21D 1/09

(57) ABSTRACT

The present invention discloses a cutting tool with a cutting edge, including a base and a cutting edge, where the cutting edge includes a laser cyclic heat treatment hardened layer, and the hardness of the hardened layer is higher than the hardness of the base. The present invention also discloses a method for manufacturing the foregoing tool.

### FIELD OF THE INVENTION

The present invention relates to the field of tools, and in particular, to a cutting tool with a cutting edge.

### DESCRIPTION OF THE PRIOR ART

Currently, common tools with a cutting edge are knife-type tools, pliers-type tools, and the like.

The common knife-type tools include a utility knife with a utility blade shown in FIG. 1 and a conventional stainless steel-type tool such as a folding knife, a single blade knife, a hacking knife, a dagger, scissors, pliers, a tube cutting knife, a shovel blade, or the like. The common pliers-type tools are wire pliers, diagonal cutting pliers, long flat nose pliers, and the like.

In the prior art, during utility blade manufacturing, a base is generally made of high carbon tool steel (such as T8, T8Mn, T9, T10, T11, T12, or T13). The utility blade is assembled after conventional quenching, tempering, grinding, and edging.

Specifically, in the prior art, for the utility blade, heat treatment including quenching and tempering is performed only once in a protective atmosphere heating furnace, a heating speed and a quenching cooling speed of the utility blade are relatively slow, the grain size of the blade after the quenching is relatively large, the grain size number is approximately 7-9, and the strength is relatively low. The hardness of the entire blade including a cutting edge and the base is approaching uniform. However, in a grinding and edging process, because a relatively large amount of grinding heat is generated during cutting edge grinding, a function similar to tempering is caused to the cutting edge. The hardness of the cutting edge after the grinding is even approximately 0.5-1.0 HRC lower than the hardness of the base. Therefore, when the overall hardness of the utility blade is relatively high, the abrasion resistance of the cutting edge is relatively good, but the overall fragility of the blade is relatively large. When the overall hardness of the utility blade is relatively low, the overall toughness of the blade is relatively good, but the abrasion resistance of the cutting edge is relatively low, and the service life is short.

In the prior art, a cutting edge and a base of the stainless steel-type tool are generally made of martensite steel (such as 20Cr13, 30Cr13, 40Cr13, 50Cr15MoV, 68Cr17, 95Cr18, or 90Cr18MoV). Conventional quenching and tempering are performed, and then grinding and edging are performed. Similarly, for the stainless steel-type tool, heat treatment including quenching and tempering is performed only once in a protective atmosphere heating furnace, a heating speed and a quenching cooling speed are relatively slow, the grain size of the stainless steel knife after the quenching is relatively large, the grain size number is approximately 7-9, and the strength is relatively low. The hardness of the entire stainless steel knife including the cutting edge and the base is approaching uniform. However, in a grinding and edging process, because a relatively large amount of grinding heat is generated during cutting edge grinding, a function similar to tempering is caused to the cutting edge. The hardness of the cutting edge after the grinding is even approximately 0.5-1.5 HRC lower than the hardness of the base. When the overall hardness of the tool is relatively high, the abrasion resistance of the cutting edge is relatively good, but the overall fragility of the tool is relatively large. When the overall hardness of the tool is relatively low, the overall toughness of the tool is relatively good, but the abrasion resistance of the cutting edge is relatively low, and the service life is short.

In the prior art, a base of a pliers-type product is generally made of carbon steel or alloy steel (such as 55#, 50CrV, 60CrV, or 55CrNi). The pliers-type product is assembled after blanking, hot forging, machining, riveting arrangement, integral heat treatment, cutting edge high-frequency quenching, arrangement, and surface treatment. For the pliers-type tool, the cutting edge high-frequency quenching is manually performed. Fluctuations of a heating time and a heating location are relatively great, changes of the thickness of a corresponding quench-hardened layer and a location of the quench-hardened layer are also relatively great, a high-frequency heating time is relatively long, and a grain structure of a quenched cutting edge is also relatively large. The pliers-type tool also has a problem the same as the problems of the utility blade and stainless steel-type tool.

Therefore, a person skilled in the art works for developing a tool including a base with relatively low hardness and relatively high toughness and a cutting edge with relatively high hardness and abrasion resistance, and a method for manufacturing same.

### SUMMARY OF THE INVENTION

In view of the foregoing disadvantages in the prior art, a technical problem to be resolved in the present invention is to provide a tool including a base with relatively low hardness and relatively high toughness and a cutting edge with relatively high hardness and abrasion resistance, and a method for manufacturing same.

To achieve the foregoing objective, the present invention provides a cutting tool with a cutting edge, including a base and a cutting edge, where the cutting edge includes a laser cyclic heat treatment hardened layer, and the hardness of the hardened layer is higher than the hardness of the base.

In a preferred implementation of the present invention, the hardness of the laser cyclic heat treatment hardened layer is greater than 58 HRC. Further, the hardness of the laser cyclic heat treatment hardened layer is 62-68 HRC.

In another preferred implementation of the present invention, the thickness of the laser cyclic heat treatment hardened layer is 0.20-2.50 mm. Further, the thickness of the laser cyclic heat treatment hardened layer is 0.30-1.80 mm.

In another preferred implementation of the present invention, a transition layer is located between the laser cyclic heat treatment hardened layer and the base. Further, the thickness of the transition layer is 0.10-0.80 mm. Furthermore, the thickness of the transition layer is 0.20-0.60 mm.

In another preferred implementation of the present invention, the cutting tool with a cutting edge is a utility blade or a tool with a utility blade. Further, the hardness of the laser cyclic heat treatment hardened layer is 65-66 HRC. Further, the thickness of the laser cyclic heat treatment hardened layer is 0.40-0.45 mm. Furthermore, a transition layer is located between the laser cyclic heat treatment hardened layer and the base, and the thickness of the transition layer is 0.25-0.35 mm.

In another preferred implementation of the present invention, the base is made of high carbon tool steel. Further, the high carbon tool steel is T8, T8Mn, T9, T10, T11, T12, or T13.

In another preferred implementation of the present invention, the cutting tool with a cutting edge is a tool with a stainless steel cutting edge. Further, the tool with a stainless steel cutting edge is a folding knife, scissors, pliers, a cutting knife, a shovel blade, a single bevel knife, or a dagger, and stainless steel is 20Cr13, 30Cr13, 40Cr13, 50Cr15MoV, 68Cr17, 95Cr18, or 90Cr18MoV.

In another preferred implementation of the present invention, the cutting tool with a cutting edge is a pliers-type tool. Further, the pliers-type tool is long flat nose pliers, or diagonal cutting pliers, or wire pliers. The base is made of carbon steel or alloy steel. Further, the carbon steel or the alloy steel is 55#, 50CrV, 60CrV, or 55CrNi.

The present invention further provides a method for manufacturing a cutting tool with a cutting edge, including a step of performing laser cyclic quenching on a cutting edge. Further, before the performing laser cyclic quenching on a cutting edge, the method further includes a step of performing integral heat treatment on the cutting tool with a cutting edge. Furthermore, the integral heat treatment includes integral quenching and integral tempering. Furthermore, after the laser cyclic quenching, the method further includes a step of performing stress relief treatment on the cutting tool with a cutting edge, where a temperature of the stress relief treatment is 100-180° C., and a heat preservation time is 2-6 hours. A laser is provided to perform the laser cyclic quenching step, and the laser is a CO₂ gas laser, a YAG solid-state laser, an optical fiber laser, or a DIODE semiconductor laser. A stress relief device is provided to perform the stress relief treatment step, and the stress relief device is a protective gas continuous furnace, or a protective gas periodic box-type furnace or multipurpose furnace.

In a preferred implementation of the present invention, the cutting tool with a cutting edge is a utility blade or a tool with a utility blade, and a relative movement speed of a laser head of a laser configured to perform the laser cyclic quenching is 1.0-30.0 m/min. The cutting tool with a cutting edge is a tool with a stainless steel cutting edge, and a relative movement speed of a laser head of a laser configured to perform the laser cyclic quenching is 2.0-20.0 mm/s.

In another preferred implementation of the present invention, the cutting tool with a cutting edge is a pliers-type tool, the laser cyclic quenching is performed two or more than two times, and a relative movement speed of a laser head of a laser configured to perform the laser cyclic quenching is 2.0-20.0 mm/s.

A test result proves that the present invention provides a cutting tool with a cutting edge and a method for manufacturing same, so that grains of the cutting edge are refined while a base of the tool has relatively low hardness and relatively high toughness. Therefore, the cutting edge has relatively high hardness and abrasion resistance, thereby greatly improving working life of the tool.

The following further describes the idea, specific structure, and generated technical effects of the present invention with reference to the accompany drawings, to fully understand the objective, features, and effects of the present invention.

### BRIEF DESCRIPTION OF THE DRAWINGS

FIG. 1 is a schematic diagram of a utility blade according to an embodiment of the present invention;

FIG. 2 is a schematic diagram of a folding knife according to an embodiment of the present invention;

FIG. 3 is a schematic diagram of scissors according to an embodiment of the present invention;

FIG. 4 is a schematic diagram of pliers according to an embodiment of the present invention;

FIG. 5 is a schematic diagram of a cutting knife according to an embodiment of the present invention;

FIG. 6 is a schematic diagram of a shovel blade according to an embodiment of the present invention;

FIG. 7 is a schematic diagram of diagonal cutting pliers according to an embodiment of the present invention;

FIG. 8 is a schematic diagram of wire pliers according to an embodiment of the present invention;

FIG. 9 is a schematic diagram of a transition layer according to an embodiment of the present invention;

FIG. 10 is a metallographic structure diagram of a cutting edge of a utility blade according to an embodiment of the present invention;

FIG. 11 is test data about sharpness/durability of a utility blade according to an embodiment of the present invention; and

FIG. 12 is a schematic diagram of laser cyclic quenching.

### DETAILED DESCRIPTION OF THE PREFERRED EMBODIMENTS

For a person skilled in the art related to the present invention, heat treatment, quenching, tempering, high-frequency quenching, and laser cyclic quenching, and other technical content and terms thereof in the present invention are all known and determined.

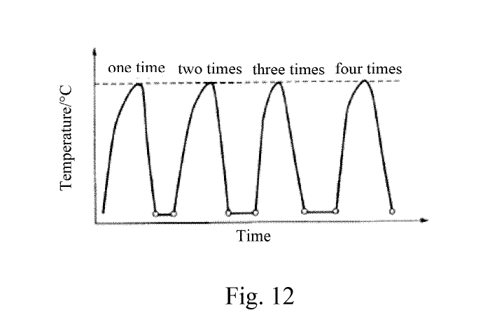

Grain refinement is one of effective ways for strengthening a metal material. Laser cyclic quenching is rapidly heating a metal material to above a temperature AC1. Austenite grains in a heated area may rapidly nucleate at an original grain boundary, and before a new grain is grown up, the grains are transformed into a martensite structure through rapid cooling, so that a relatively small martensite grain structure is obtained. Rapid heating and rapid cooling are repeatedly performed on the metal material one or more times, to perform “cyclic quenching” shown in FIG. 12, thereby refining grains and strengthening the metal material.

The present invention is applicable to a cutting tool with a cutting edge. The following describes specific implementations and examples that are implemented according to the present invention.

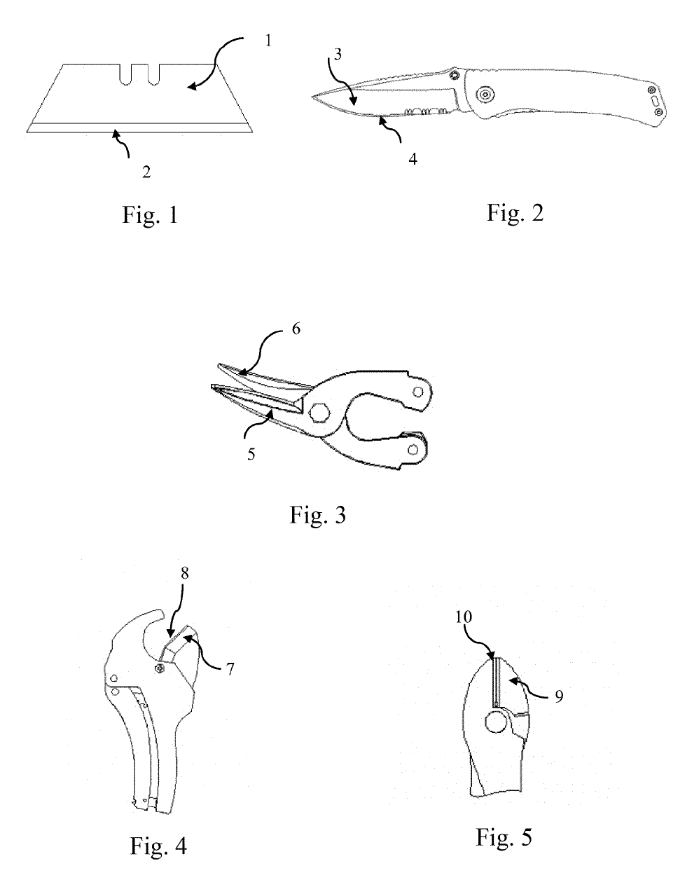

FIG. 1 shows a utility blade, including a base 1 and a cutting edge 2. The base 1 of the utility blade is made of high carbon tool steel such as T8, T8Mn, T9, T10, T11, T12, or T13. In an embodiment of the present invention, to improve the hardness and the abrasion resistance of the cutting edge 2, after integral quenching, integral tempering, grinding, and edging are performed on the blade, laser cyclic quenching is performed on the cutting edge 2, so that a laser cyclic heat treatment hardened layer whose hardness is higher than the hardness of the base 1 is obtained at the cutting edge 2. In this embodiment, the hardness of the hardened layer reaches 65-66 HRC, and the thickness is 0.40-0.45 mm Generally, a laser may be a CO₂ gas laser, a YAG solid-state laser, an optical fiber laser, or a DIODE semiconductor laser. In this embodiment, the DIODE semiconductor laser is used, the power of the DIODE semiconductor laser is above 500 W, and a relative movement speed of a laser head during the laser cyclic quenching is 1.0-30.0 m/min.

Then, to relieve structural stress and make performance of the utility blade more stable, stress-relief low-temperature tempering treatment is performed on the utility blade. A used stress relief device may be a protective gas continuous furnace (for example, corresponding to the utility blade), or a protective gas periodic box-type furnace or multipurpose furnace (for example, corresponding to a stainless steel tool or a carbon steel/alloy steel pliers-type product). A temperature of the stress relief treatment is 100-180° C., and a heat preservation time is 2-6 hours.

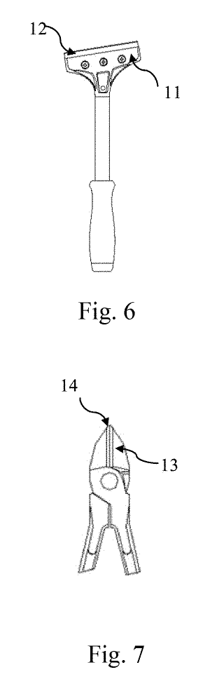

The present invention is also applicable to a tool with a stainless steel cutting edge, including a folding knife including a base 3 and a cutting edge 4 shown in FIG. 2, scissors including a base 5 and a cutting edge 6 shown in FIG. 3, pliers including a base 7 and a cutting edge 8 shown in FIG. 4, a cutting knife including a base 9 and a cutting edge 10 shown in FIG. 5, a shovel blade including a base 11 and a cutting edge 12 shown in FIG. 6, and others such as a single bevel knife and a dagger that are not shown. Stainless steel is generally 20Cr13, 30Cr13, 40Cr13, 50Cr15MoV, 68Cr17, 95Cr18, 90Cr18MoV, or the like. In an embodiment of the present invention, after integral quenching, integral tempering, grinding, and edging are performed on the tool with a stainless steel cutting edge, laser cyclic quenching is performed on the cutting edge, so that a laser cyclic heat treatment hardened layer whose hardness is higher than the hardness of the base is obtained at the cutting edge. In this embodiment, the hardness of the hardened layer may be above 58 HRC, and preferably is 62-68 HRC; the thickness of the hardened layer is 0.20-2.50 mm, and preferably is 0.30-1.80 mm Generally, a laser may be a CO₂ gas laser, a YAG solid-state laser, an optical fiber laser, or a DIODE semiconductor laser. In this embodiment, the DIODE semiconductor laser is used, the power of the DIODE semiconductor laser is above 500 W, and a relative movement speed of a laser head during the laser cyclic quenching is 2.0-20.0 mm/s. Then, to relieve structural stress and make performance of the tool with a stainless steel cutting edge more stable, stress-relief low-temperature tempering treatment is performed on the tool with a stainless steel cutting edge. A used stress relief device may be a protective gas continuous furnace (for example, corresponding to a utility blade), or a protective gas periodic box-type furnace or multipurpose furnace (for example, corresponding to the stainless steel tool or a carbon steel/alloy steel pliers-type product). A temperature of the stress relief treatment is 100-180° C., and a heat preservation time is 2-6 hours.

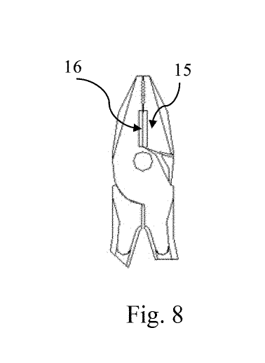

The present invention is also applicable to a pliers-type tool, including diagonal cutting pliers including a base 13 and a cutting edge 14 shown in FIG. 7 and FIG. 8, and wire pliers including a base 15 and a cutting edge 16. In the pliers-type tool, the base is generally made of carbon steel or alloy steel, such as 55#, 50CrV, 60CrV, or 55CrNi. In an embodiment of the present invention, after conventional blanking, hot forging, machining, riveting arrangement, and integral heat treatment are performed on the pliers-type tool, laser cyclic quenching is performed on the cutting edge of the pliers-type tool two or more than two times, to obtain a laser cyclic heat treatment hardened layer at the cutting edge of the pliers-type product, and the hardness of the hardened layer is higher than the hardness of the base. In this embodiment, the hardness of the hardened layer may be above 58 HRC, and preferably is 62-68 HRC; the thickness of the hardened layer is 0.20-2.50 mm, and preferably is 0.30-1.80 mm Generally, a laser may be a CO₂ gas laser, a YAG solid-state laser, an optical fiber laser, or a DIODE semiconductor laser. The DIODE semiconductor laser is used, the power of the DIODE semiconductor laser is above 500 W, and a relative movement speed of a laser head during the laser cyclic quenching is 2.0-20.0 mm/s. Then, to relieve structural stress and make performance of the pliers-type tool more stable, stress-relief low-temperature tempering treatment is performed on the pliers-type tool. In this embodiment, a used stress relief device may be a protective gas continuous furnace (for example, corresponding to a utility blade), or a protective gas periodic box-type furnace or multipurpose furnace (for example, corresponding to a stainless steel tool or the carbon steel/alloy steel pliers-type product). A temperature of the stress relief treatment is 100-180° C., and a heat preservation time is 2-6 hours.

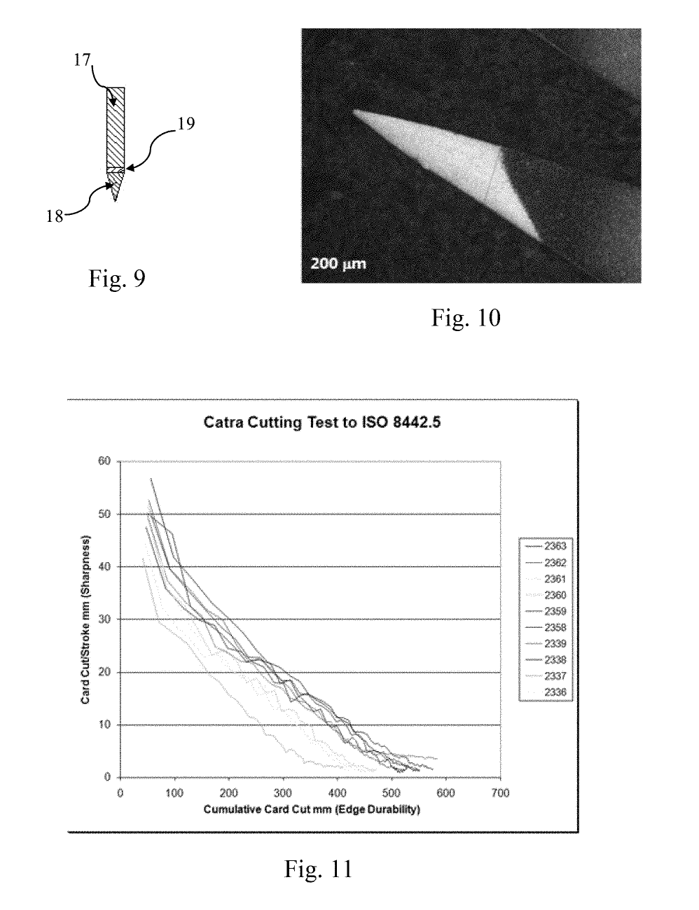

Further, it is found that in the foregoing embodiments, a transition layer exists between the formed laser cyclic quenching hardened layer and the material of the base of the tool, as shown in FIG. 9 and FIG. 10. Because when the laser cyclic quenching is performed, a direction of a laser beam is perpendicular to a plane of the cutting edge. The laser cyclic quenching transition layer actually includes a small part of a hardened layer extended from the laser cyclic quenching hardened layer and a laser heat affected zone next to the hardened layer. The hardness of the part of the hardened layer in the transition layer may be the same as the hardness of the laser cyclic quenching hardened layer, and the hardness of the laser heat affected zone is lower than the hardness of the base. The thickness of the formed laser cyclic quenching transition layer is 0.1-0.8 mm Preferably, the thickness of the formed laser cyclic quenching transition layer is 0.2-0.6 mm. In the embodiment of the utility blade, the thickness of the laser cyclic quenching transition layer of the utility blade is 0.25-0.35 mm.

FIG. 11 shows a life test result of the utility blade in the embodiment of the utility blade. A vertical coordinate is the cutting thickness during each cyclic cutting during a test, and a horizontal coordinate is the cutting thickness accumulated during the test. In the test, the total cutting thickness after 60 continuous cycle tests is the cutting life of the blade. In the prior art, the cutting life of the utility blade is approximately 180-220.

In the embodiment of the utility blade, after the laser cyclic quenching is performed, the hardness of the cutting edge of the utility blade is 66-67 HRC. However, the hardness of the base is 62 HRC. The hardness of the formed laser cyclic quenching hardened layer of the utility blade is 4-5 HRC higher than the hardness of the base, and the cutting life is prolonged by 2-3 times. Compared with the grain size number 7-9 obtained after an existing process treatment, the grain size number of the cutting edge of the utility blade according to the embodiment of the present invention reaches 10-11.

Specific preferred embodiments of the present invention are described above in detail. It should be understood that a person of ordinary skill in the art may made various modifications and changes according to the idea of the present invention without creative effort. Therefore, any technical solution that can be obtained according to the idea of the present invention through logic analysis, reasoning, or limited experiments should be within the protection scope determined by the claims.

1. A cutting tool with a cutting edge, comprising a base and a cutting edge, wherein the cutting edge comprises a laser cyclic heat treatment hardened layer, and the hardness of the hardened layer is higher than the hardness of the base.

2. The cutting tool with a cutting edge according to claim 1, wherein the hardness of the laser cyclic heat treatment hardened layer is 62-68 HRC.

3. The cutting tool with a cutting edge according to claim 1, wherein the thickness of the laser cyclic heat treatment hardened layer is 0.30-1.80 mm.

4. The cutting tool with a cutting edge according to claim 1, wherein a transition layer is located between the laser cyclic heat treatment hardened layer and the base, and the thickness of the transition layer is 0.20-0.60 mm.

5. The cutting tool with a cutting edge according to claim 1, wherein the cutting tool with a cutting edge is a utility blade or a tool with a utility blade.

6. The cutting tool with a cutting edge according to claim 5, wherein the hardness of the laser cyclic heat treatment hardened layer is 65-66 HRC.

7. The cutting tool with a cutting edge according to claim 5, wherein the thickness of the laser cyclic heat treatment hardened layer is 0.40-0.45 mm.

8. The cutting tool with a cutting edge according to claim 5, wherein a transition layer is located between the laser cyclic heat treatment hardened layer and the base, and the thickness of the transition layer is 0.25-0.35 mm.

9. The cutting tool with a cutting edge according to claim 5, wherein the base is made of high carbon tool steel.

10. The cutting tool with a cutting edge according to claim 1, wherein the cutting tool with a cutting edge is a tool with a stainless steel cutting edge, comprising a folding knife, scissors, pliers, a cutting knife, a shovel blade, a single bevel knife, and a dagger.

11. The cutting tool with a cutting edge according to claim 1, wherein the cutting tool with a cutting edge is a pliers-type tool, comprising long flat nose pliers, diagonal cutting pliers, and wire pliers.

12. The cutting tool with a cutting edge according to claim 11, wherein the base is made of carbon steel or alloy steel.

13. A method for manufacturing a cutting tool with a cutting edge, comprising a step of performing laser cyclic quenching on a cutting edge.

14. The method for manufacturing a cutting tool with a cutting edge according to claim 13, wherein before the performing laser cyclic quenching on a cutting edge, the method further comprises a step of performing integral heat treatment on the cutting tool with a cutting edge, and the integral heat treatment comprises integral quenching and integral tempering.

15. The method for manufacturing a cutting tool with a cutting edge according to claim 13, wherein after the laser cyclic quenching, the method further comprises a step of performing stress relief treatment on the cutting tool with a cutting edge.

16. The method for manufacturing a cutting tool with a cutting edge according to claim 15, wherein a temperature of the stress relief treatment is 100-180° C., and a heat preservation time is 2-6 hours.

17. The method for manufacturing a cutting tool with a cutting edge according to claim 13, wherein the cutting tool with a cutting edge is a utility blade or a tool with a utility blade, the laser cyclic quenching is performed one or more times, and a relative movement speed of a laser head of a laser configured to perform the laser cyclic quenching is 1.0-30.0 m/min.

18. The method for manufacturing a cutting tool with a cutting edge according to claim 13, wherein the cutting tool with a cutting edge is a tool with a stainless steel cutting edge, the laser cyclic quenching is performed one or more times, and a relative movement speed of a laser head of a laser configured to perform the laser cyclic quenching is 2.0-20.0 mm/s.

19. The method for manufacturing a cutting tool with a cutting edge according to claim 13, wherein the cutting tool with a cutting edge is a pliers-type tool, the laser cyclic quenching is performed two or more than two times, and a relative movement speed of a laser head of a laser configured to perform the laser cyclic quenching is 2.0-20.0 mm/s.
